(19) United States
(12) Patent Application Publication
(10) Pub. No.: US 2018/0044978 A1
(43) Pub. Date: Feb. 15, 2018

(54) ROMAN SHADE WITH MAGNETIC MEMBERS

(71) Applicants: SHENG YING HSU, Changhua County (TW); CHUN JAN HSU, Changhua County (TW)

(72) Inventors: SHENG YING HSU, Changhua County (TW); CHUN JAN HSU, Changhua County (TW)

(21) Appl. No.: 15/668,022

(22) Filed: Aug. 3, 2017

(30) Foreign Application Priority Data
Aug. 9, 2016 (TW) 105212015

(51) Int. Cl. E06B 9/262; H01F 7/02; E06B 9/30

(52) U.S. Cl. CPC E06B 9/262; E06B 9/30; H01F 7/0252; E06B 2009/2622; E06B 2009/3222

(57) ABSTRACT

A Roman shade includes a top rail having multiple hooks, and a shade connected to the top rail and including multiple slots. Multiple magnetic members connected to the slots of the shade. Each magnetic member includes a first part and a second part. The first part has a first magnet received therein. Two hooking members extend from the first side thereof. The second part includes a recess in which a second magnet is received. The second part includes two holes with which the hooking members of the first part are engaged. When the shade is folded upward section by section, the first magnets and the second magnets are magnetically attracted to each other.

### BACKGROUND OF THE INVENTION

### 1. Fields of the Invention

The present invention relates to a Roman shade, and more particularly, to a Roman shade with magnetic members which magnetically attracted to each other so as to organize the shade to be overlapped when the shade is folded.

### 2. Descriptions of Related Art

The conventional window curtains are generally controlled by control ropes which hang downward from the top box. The control ropes include potential risks, especially when kids play the control ropes which may warp the kids' necks. Applicant developed several window curtains without control ropes, and were disclosed in U.S. Pat. No. 7,150,302, and U.S. patent application Ser. Nos. 14/927,417, 15/091,590 and 15/237,633. The window curtains have magnets which make the window curtains to be easily positioned when being folded.

However, the magnets are received in pockets of the curtain, and the pockets are sealed by way of sewing. The sewing takes time and causes visible seams which may not be straight and affect the aesthetic purposes.

The present invention intends to provide a Roman shade with magnetic members wherein the magnetic members are composed of a first part and a second part which is snapped to the first part. No sewing action needed to position the magnetic members.

### SUMMARY OF THE INVENTION

The present invention relates to a Roman shade and comprises a top rail having multiple hooks, and a shade connected to the top rail and including multiple slots. Multiple magnetic members connected to the slots of the shade. Each magnetic member includes a first part and a second part. The first part has a first magnet received therein. Two hooking members extend from the first side thereof. The second part includes a recess in which a second magnet is received. The second part includes two holes with which the hooking members of the first part are engaged. When the shade is folded upward section by section, the first magnets and the second magnets are magnetically attracted to each other.

Preferably, the first magnet is received in the first part by way of plastic injection molding.

Preferably, the first magnet is received in the first part by way of ultra-sonic welding.

Preferably, the first magnet is located between the two hooking members which are located along the axial direction of the shade.

Preferably, the first magnet is received in the first part by way of gluing.

Preferably, the shade has a handle on the lower portion thereof.

Preferably, the second magnet is received in the recess by way of plastic injection molding.

Preferably, the second magnet is received in the recess by way of ultra-sonic welding.

Preferably, the second magnet is received in the recess by way of gluing.

Preferably, each of the hooking members includes an inclined face.

The advantages of the present invention are that the Roman shade comprises multiple magnetic members, and each magnetic member includes a first part and a second part which is snapped to the first part to easily secure the magnetic member to the shade. The shade is folded section by section by attracting the magnetic members of each section.

The magnets are secured to the first and second parts by plastic injection molding, gluing or ultra-sonic welding.

The first parts each include two hooking members, and each second part includes two holes so that the first parts are easily connected to the second parts by engaging the hooking members with the holes.

The shade provides a handle or a pulling plate on the lower end thereof for convenience of operation to the shade.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the Roman shade of the present invention;

FIG. 2 is an exploded view of the first part, the second part and a portion of the shade of the Roman shade of the present invention;

FIG. 3 shows that the first part and the second part are connected to each other, and secured to the shade of the Roman shade of the present invention;

FIG. 4 is a cross sectional view to show the connection of first part, the second part and the shade of the Roman shade of the present invention;

FIG. 5 shows that the Roman shade of the present invention is folded section by section;

FIG. 6 is a cross sectional view to show the magnetic members magnetically attracted to each other when the Roman shade of the present invention is folded section by section, and

FIG. 7 shows two Roman shade of the present invention are used side by side.

### DETAILED DESCRIPTION OF THE PREFERRED EMBODIMENT

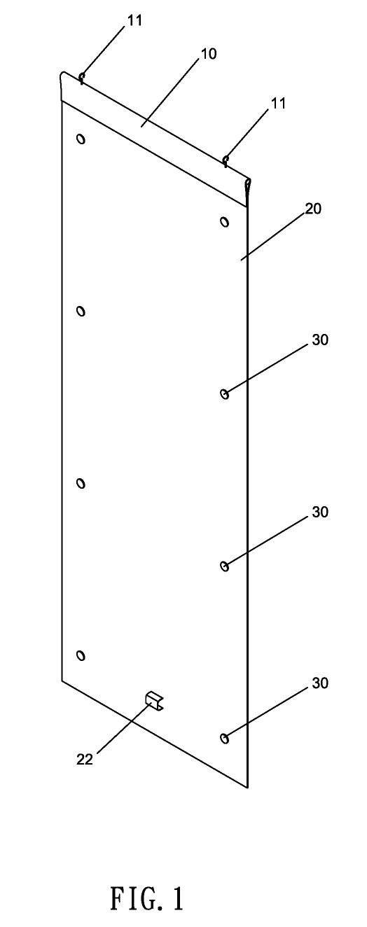

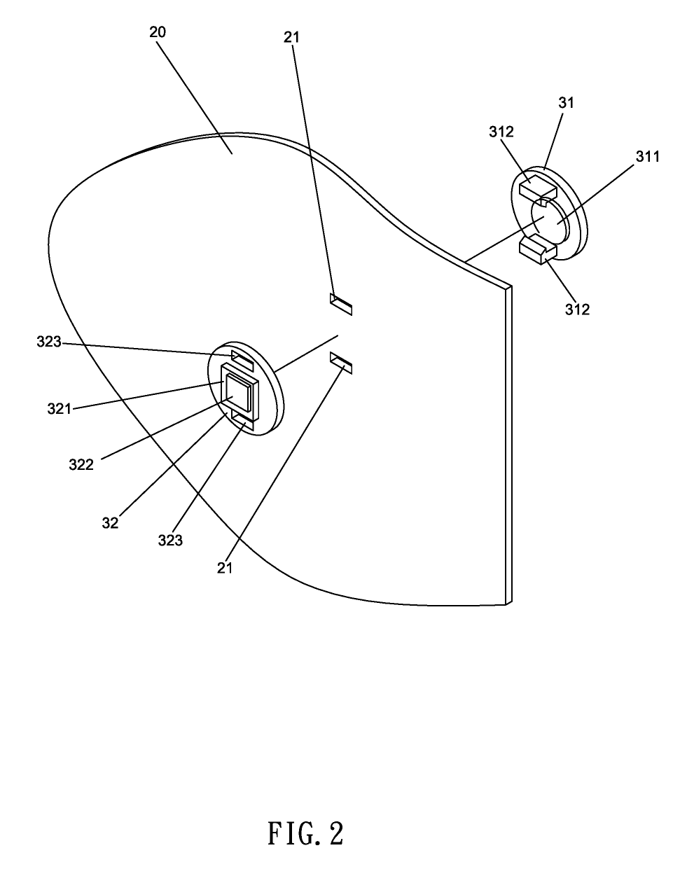

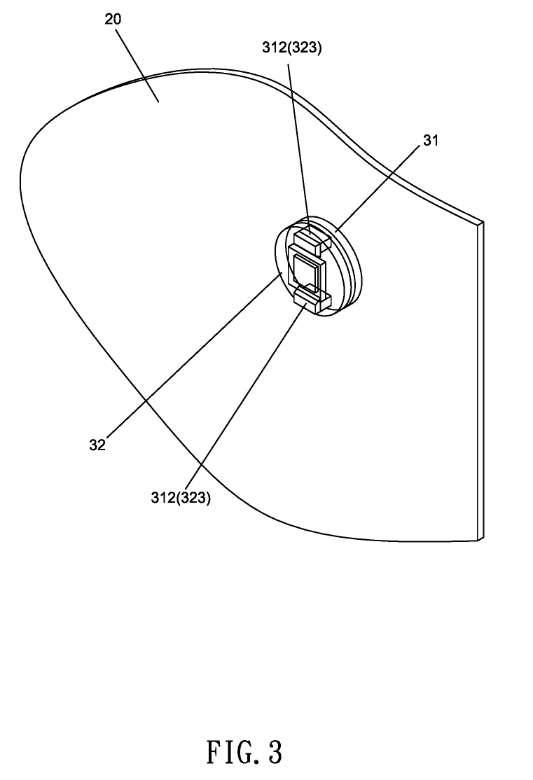

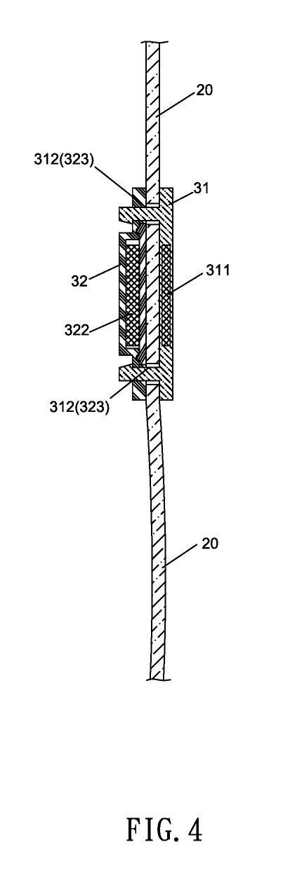

Referring to FIGS. 1 to 6, the Roman shade of the present invention comprises a top rail 10 having multiple hooks 11 which are used to hook the Roman shade on the top of the window. A shade 20 is connected to the top rail 10 and includes multiple slots 21 which are designed such that multiple magnetic members 30 are connected to the slots 21 of the shade 20.

Each magnetic member 30 includes a first part 31 and a second part 32 which is to be connected to the second part 32 to secure the magnetic member 30 to the shade 20. The first part 31 has a first magnet 311 received therein, and two hooking members 312 extend from the first side thereof. The first magnet 311 is received in the first part 31 by way of plastic injection molding, ultra-sonic welding or gluing. The first magnet 311 is located between the two hooking members 312 which are located along the axial direction of the shade 20. Each of the hooking members 312 includes an inclined face.

The second part 32 includes a recess 321 in which a second magnet 322 is received. The second magnet 322 is received in the recess 321 by way of plastic injection molding, ultra-sonic welding or gluing. The second part 322 includes two holes 323 with which the hooking members 312 of the first part 31 are engaged. The inclined face of each hooking member 312 of the first part 31 is designed to be easily engaged with the hole 323 corresponding thereto. The shade 20 has a handle 22 or a pulling plate on the lower portion thereof so that the users can easily pull the shade 20.

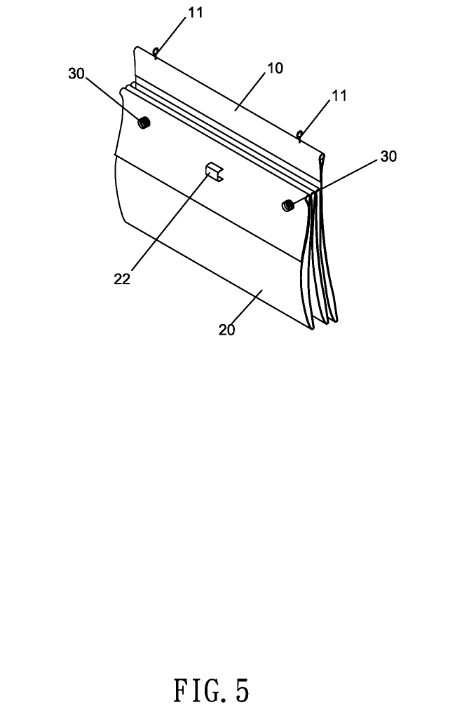

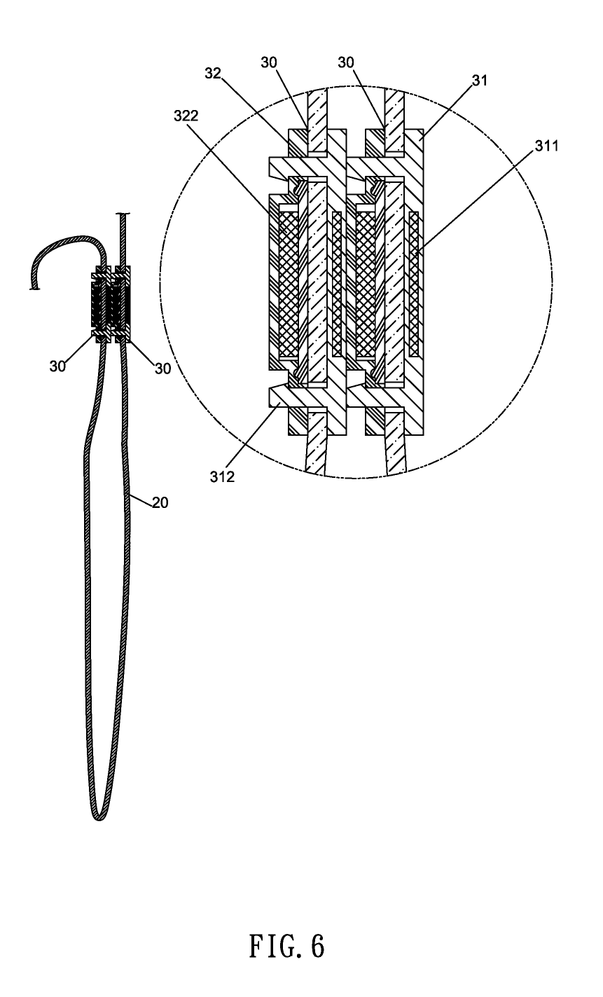

As shown in FIGS. 5 and 6, when hen the shade 20 is folded upward section by section, the first magnets 311 and the second magnets 322 are magnetically attracted to each other.

The positions of the magnetic members 30 are located symmetrically relative to the central axial line of the shade 20. The number of the magnetic members 30 can be adjusted according to the width or length of the shade 20.

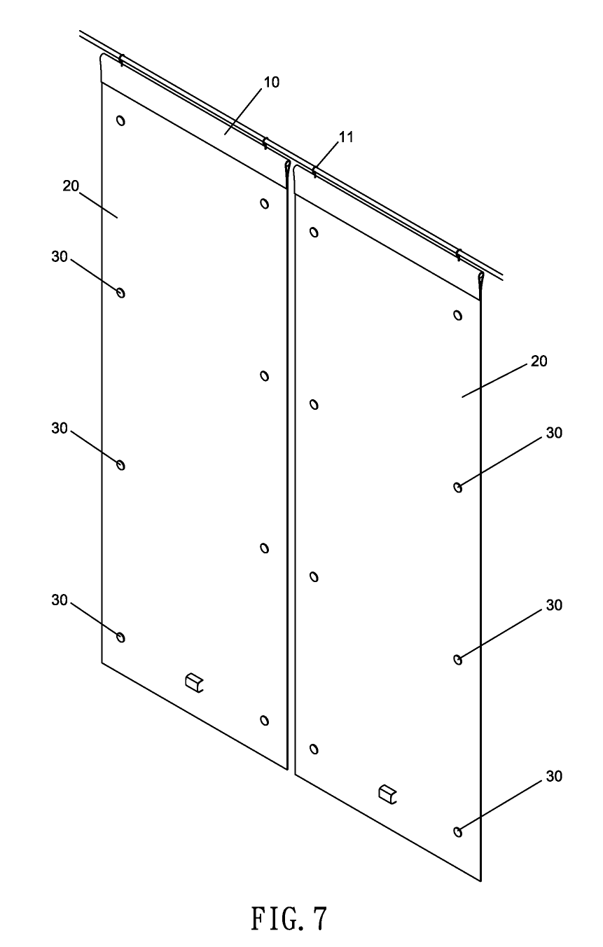

FIG. 7 shows that shows that two Roman shade of the present invention are used side by side to cover a wider window or door.

While we have shown and described the embodiment in accordance with the present invention, it should be clear to those skilled in the art that further embodiments may be made without departing from the scope of the present invention.

What is claimed is:

1. A Roman shade comprising:
a top rail having multiple hooks;
a shade connected to the top rail and including multiple slots, and
multiple magnetic members connected to the slots of the shade, each magnetic member including a first part and a second part, the first part having a first magnet received therein, two hooking members extending from a first side thereof, the second part including a recess in which a second magnet is received, the second magnet being magnetically attractable to the first magnet, the second part including two holes with which the hooking members of the first part are engaged, when the shade is folded upward section by section, the first magnets and the second magnets are magnetically attracted to each other.

2. The Roman shade as claimed in claim 1, wherein the first magnet is received in the first part by way of plastic injection molding.

3. The Roman shade as claimed in claim 1, wherein the first magnet is received in the first part by way of ultra-sonic welding.

4. The Roman shade as claimed in claim 1, wherein the first magnet is located between the two hooking members which are located along an axial direction of the shade.

5. The Roman shade as claimed in claim 1, wherein the first magnet is received in the first part by way of gluing.

6. The Roman shade as claimed in claim 1, wherein the shade has a handle on a lower portion thereof.

7. The Roman shade as claimed in claim 1, wherein the second magnet is received in the recess by way of plastic injection molding.

8. The Roman shade as claimed in claim 1, wherein the second magnet is received in the recess by way of ultra-sonic welding.

9. The Roman shade as claimed in claim 1, wherein the second magnet is received in the recess by way of gluing.

10. The Roman shade as claimed in claim 1, wherein each of the hooking members includes an inclined face.
